(19) United States
(12) Patent Application Publication
(10) Pub. No.: US 2010/0086328 A1
(43) Pub. Date: Apr. 8, 2010

(54) ORGANIC PHOTORECEPTOR, MANUFACTURING METHOD OF ORGANIC PHOTORECEPTOR, IMAGE FORMING APPARATUS AND PROCESS CARTRIDGE

(75) Inventors: Toshiyuki FUJITA, Tokyo (JP); Hirofumi HAYATA, Tokyo (JP); Takeshi ISHIDA, Tokyo (JP); Masahiko KURACHI, Tokyo (JP); Seisuke MAEDA, Tokyo (JP); Seijiro TAKAHASHI, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA BUSINESS TECHNOLOGIES, INC., Tokyo (JP)

(21) Appl. No.: 12/563,730

(22) Filed: Sep. 21, 2009

(30) Foreign Application Priority Data
Oct. 2, 2008 (JP) 2008-257201

(51) Int. Cl. G03G 21/18; G03G 5/04; G03G 15/00

(52) U.S. Cl. 399/111; 430/66; 430/132; 399/159

(57) ABSTRACT

An organic photoreceptor having a photosensitive layer, an electric conductive support, and a protective layer is disclosed, in which the protective layer comprises a composition produced by reacting metal oxide particles having a reactive organic group and an anti-oxidant. A production method of the same, an image forming apparatus and a process cartridge using the same are also disclosed.

This application is based on Japanese Patent Application No. 2008-257201 filed on Oct. 2, 2008, in Japanese Patent Office, the entire content of which is hereby incorporated by reference.

### FIELD OF THE INVENTION

The present invention directs to an organic photoreceptor used in the field of an image forming apparatus, a manufacturing method of the organic photoreceptor, an image forming apparatus employing the organic photoreceptor, and a process cartridge and an image forming apparatus using this organic photoreceptor.

### BACKGROUND

An organic photoreceptor containing an organic photoconductive material is most widely employed in the electrophotography. While the organic photoreceptor has such advantages that it is easy to develop materials corresponding to various exposing light source from visible to infrared light, materials without environmental contamination can be selected, and manufacturing cost is low, in comparison with the other photoreceptor, there is a problem that mechanical strength is weak and it is liable to generate deterioration or damage on a surface of the photoreceptor during a plenty sheets of copying or printing.

It has been strongly demanded to reduce an abrasion due to scraping by cleaning blade etc., so as to improve the durability of the organic photoreceptor. For this purpose technology to provide a protecting layer with high mechanical strength on the photoreceptor has been tried. For example, the patent document No. 1 reports that colloidal silica containing hardenable siloxane resin is used for the protective layer of the photoreceptor. The colloidal silica containing hardenable siloxane resin has high moisture absorbing characteristics both in hardenable resin having siloxane bond (Si—O—Si bond) and colloidal silica, and therefore, electric resistivity of the protective layer is liable to lower and causing image blur or image flow.

The other patent document No. 2 reports a protective layer composed of hardenable resin obtained by photopolymerizing a compound having acryloyl group etc., for the hardenable resin applied to the protective layer. Though fillers such as metal oxide are incorporated in the protective layer, bonding between the filler and the hardenable resin is weak, mechanical strength required to the protective layer is insufficient, and the problems of image blur or image flow is not dissolved sufficiently.

Patent document No. 1: JP-A H06-118681

Patent document No. 2: JP-A 2001-125297

### SUMMARY OF THE INVENTION

The object of this invention is to dissolve the above mentioned problems, so as to improve an anti-abrasion property of the photoreceptor up to the same level as an amorphous silicone photoreceptor, to improve the image blur and image flow problem liable to generate in high temperature and high moisture condition, and to provide a high durable organic photoreceptor capable of obtaining a high quality electrophotographic image. The other object is to provide an image forming apparatus and process cartridge both employing the organic photoreceptor.

A protective layer of the organic photoreceptor has been examined, and anti-abrasion property and image blur and image flow problem in the high temperature and high moisture condition are found to dissolve, by that the protective layer has a structure of strong bonding filler mutually or between the filler and hardenable resin in the hardenable resin as well as the anti-oxidant is incorporated in the protective layer.

The organic photoreceptor of this invention comprises a photosensitive layer, provided on an electric conductive support, and a protective layer, wherein the protective layer comprises a composition obtained by reacting metal oxide particles having a reactive organic group and an anti-oxidant.

### BRIEF DESCRIPTION OF THE DRAWING

FIG. 1: A schematic view of an image forming apparatus in which the organic photoreceptor is applied.

FIG. 2: A schematic view of another image forming apparatus in which the organic photoreceptor is applied.

FIG. 3: A schematic view of the other image forming apparatus in which the organic photoreceptor is applied.

### DESCRIPTION OF THE INVENTION

The organic photoreceptor of this invention comprises a photosensitive layer, provided on an electric conductive support, and a protective layer,

wherein the protective layer comprises,

a composition obtained by reacting metal oxide particles having a reactive organic group and,

an anti-oxidant.

According to this invention, mechanical strength of the surface of the photoreceptor against rubbing or abrasion is remarkably improved, and surface scratch on the surface of the photoreceptor and abrasion wastage are improved, and further the image blur problem at high temperature and high moisture is remarkably improved.

The metal oxide having a reactive organic group is preferably obtained by reacting the metal oxide particles with a silane compound having a silyl group and carbon-carbon double bond group.

The silane compound having a silyl group and carbon-carbon double bond group is preferably a compound represented by Formula (1) .

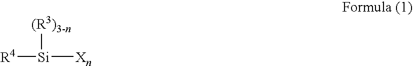

In the formula R³ is an alkyl having carbon atoms of from 1 to 10 or an aralkyl having carbon atoms of from 1 to 10, R⁴ is an organic group having polymerizable double bond, X is a halogen atom, an alkoxy, acyloxy, aminooxy or phenoxy group, n is an integer of from 1 to 3.

The reactive organic group is preferably an acryloyl or methacryloyl group.

The composition is obtained preferably by reacting metal oxide particles having a reactive organic group with a hardenable compound.

The hardenable compound is preferably a compound having carbon-carbon double bond.

The hardenable compound having carbon-carbon double bond is preferably a compound having an acryloyl or methacryloyl group.

The anti-oxidant is preferably a compound having a hindered phenol structure.

The anti-oxidant is preferably a compound having a hindered amine structure.

The image forming apparatus comprises a charging unit, an exposing unit and developing unit around an organic photoreceptor, wherein the above described organic photoreceptor is employed.

The process cartridge used for the image forming apparatus comprises the organic photoreceptor described above, and at least one of a charging unit, exposing unit and a developing unit integrally, wherein the process cartridge is detachable from main frame of the image forming apparatus.

Metal oxide particles having a reactive organic group used in this invention are described.

Metal oxide particles having a reactive organic group used in this invention can be prepared by a method, wherein a silane compound having a silyl group and carbon-carbon double bond group is allowed to react with the metal oxide particles having hydroxy group. The metal oxide particles which have not been subjected to a surface treatment have hydroxy groups on their surface in general.

The silane compound having a silyl group and carbon-carbon double bond group is preferably represented by the Formula (1).

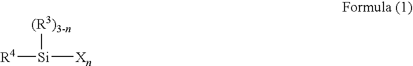

In the formula R³ is a hydrogen atom, an alkyl having carbon atoms of from 1 to 10 or an aralkyl having carbon atoms of from 6 to 10, R⁴ is an organic group having polymerizable double bond, X is a halogen atom, an alkoxy, acyloxy, aminooxy or phenoxy group, n is an integer of from 1 to 3.

R³ is preferably a hydrogen atom, and a methyl or ethyl group.

X contributes to a reaction with hydroxy groups on the surface of the metal oxide particles, and preferably halogen atoms, particularly a chlorine atom, and an alkoxy group, particularly a methoxy and ethoxy group.

R⁴ is a group to contributes to a polymerization reaction and contains polymerizable double bond such as vinyl group. Preferable examples are CH₂═CH—, CH₂═CHCOO—, CH₂═CHCOO(CH₂)₂—, CH₂═CHCOO(CH₂)₃—, CH₂═C(CH₃)COO—, CH₂═C(CH₃)COO(CH₂)₂—, and CH₂═C(CH₃)COO(CH₂)₃—.

The silane compounds to be reacted with metal oxide particles are not restricted as far as they have a hydrolizable silyl group capable of radical polymerization. Examples of compounds represented by the Formula (1) below.

Polymerizable silane compound represented by Formula (1) is not particularly restricted as far as it comprises a silyl group, in particular, which has a hydrolysable group. Examples of the polymerizable silane compound include:

S-1 CH₂═CHSi(CH₃)(OCH₃)₂

S-2 CH₂═CHSi(OCH₃)₃

S-3 CH₂═CHSiCl₃

S-4 CH₂═CHCOO(CH₂)₂Si(CH₃)(OCH₃)₂

S-5 CH₂═CHCOO(CH₂)₂Si(OCH₃)₃

S-6 CH₂═CHCOO(CH₂)₃Si(CH₃)(OCH₃)₂

S-7 CH₂═CHCOO(CH₂)₃Si(OCH₃)₃

S-8 CH₂═CHCOO(CH₂)₂Si(CH₃)Cl₂

S-9 CH₂═CHCOO(CH₂)₂SiCl₃

S-10 CH₂═CHCOO(CH₂)₃Si(CH₃)Cl₂

S-11 CH₂═CHCOO(CH₂)₃SiCl₃

S-12 CH₂═C(CH₃)COO(CH₂)₂Si(CH₃)(OCH₃)₂

S-13 CH₂═C(CH₃)COO(CH₂)₂Si(OCH₃)₃

S-14 CH₂═C(CH₃)COO(CH₂)₃Si(CH₃)(OCH₃)₂

S-15 CH₂═C(C₃)COO(CH₂)₃Si(OCH₃)₃

S-16 CH₂═C(CH₃)COO(CH₂)₂Si(CH₃)Cl₂

S-17 CH₂═C(CH₃)COO(CH₂)₂SiCl₃

S-18 CH₂═C(CH₃)COO(CH₂)₃Si(CH₃)Cl₂

S-19 CH₂═C(CH₃)COO(CH₂)₃SiCl₃

S-20 CH₂═CHSi(C₂H₅)(OCH₃)₂

S-21 CH₂═C(CH₃)Si(OCH₃)₃

S-22 CH₂═C(CH₃)Si(OC₂H₅)₃

S-23 CH₂═CHSi(OCH₃)₃

S-24 CH₂═C(CH₃)Si(CH₃)(OCH₃)₂

S-25 CH₂—CHSi(CH₃)Cl₂

S-26 CH₂═CHCOOSi(OCH₃)₃

S-27 CH₂═CHCOOSi(OC₂H₅)₃

S-28 CH₂═C(CH₃)COOSi(OCH₃)₃

S-29 CH₂═C(CH₃)COOSi(OC₂H₅)₃

S-30 CH₂═C(CH₃)COO(CH₂)₃Si(OC₂H₅)₃

S-31 CH₂═CHCOO(CH₂)₂Si(CH₃)₂(OCH₃)

S-32 CH₂═CHCOO(CH₂)₂Si(CH₃)(OCOCH₃)₂

S-33 CH₂═CHCOO(CH₂)₂Si(CH₃)(ONHCH₃)₂

S-34 CH₂═CHCOO(CH₂)₂Si(CH₃)(OC₆H₅)₂

S-35 CH₂═CHCOO(CH₂)₂S(C₁₀H₂₁)(OCH₃)₂

S-35 CH₂═CHCOO(CH₂)₂Si(CH₂C₆H₅)(OCH₃)₂

Silane compounds having a reactive organic group capable of radical polymerization may be employed in addition to the compounds represented by the formula (1). The compounds are listed.

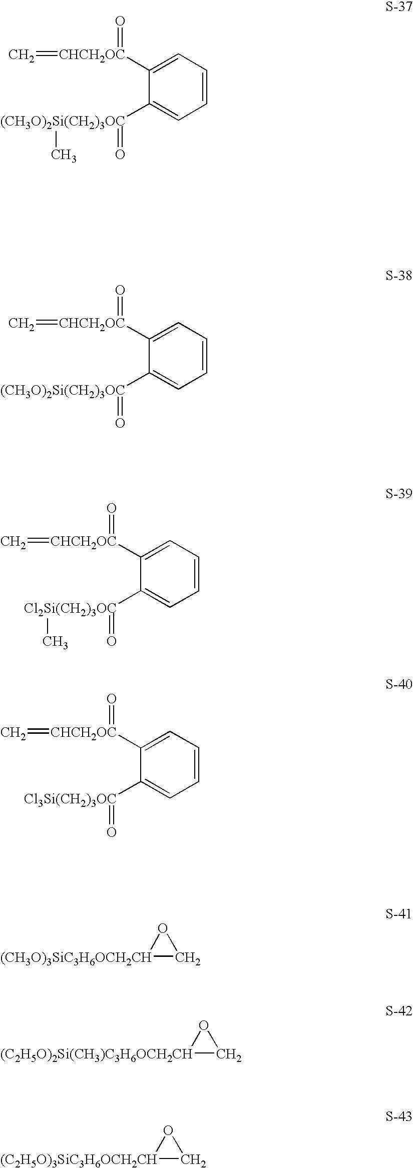

The silane compounds may be used singly or by mixing two or more.

A method for preparation of metal oxide particles having a reactive organic group are described by taking titanium oxide as an example.

### Preparation Method of Titanium Oxide Particles Having Reactive Organic Group

The titanium oxide particles having a reactive organic group can be obtained by surface treatment of the titanium oxide particles with a silane compound. The silane compound of 0.1 to 100 parts by weight as the surface treating agent and a solvent of 50 to 5,000 parts by weight are used for 100 parts by weight of titanium oxide particles by employing wet type medium dispersion apparatus for the surface treatment.

A surface treatment method is described to produce titanium oxide particles uniformly and minutely surface treated with a silane compound.

Titanium oxide particles are pulverized into particles, and simultaneously, surface treatment of the titanium oxide particles is progressed by pulverizing in wet method wherein slurry containing titanium oxide particle and silane compound surface treatment agent (suspension of solid particles). After that particulates are formed by removing solvent, titanium oxide particles surface of which is treated with uniform and minute silane compound can be obtained.

A wet type medium dispersion apparatus used for the surface treatment comprises a container filled with beads as medium, and it crushes aggregation of metal oxide particles to pulverizes and disperse by rotating stirring disk arranged perpendicular to rotation shaft with high speed. Various type of apparatus such as longitudinal or horizontal, continuous or batch type, may be employed as far as it disperses the metal oxide particles and capable of surface treating. Practical examples include sand mill, ultravisco mill, pearl mill, grain mill, DYNO-MILL, agitator mill, and dynamic mill. The dispersion apparatus employs pulverizing medium such as balls and beads, to make fine pulverizing and dispersing via impact pressure crushing, friction, shearing, shearing stress and so on.

Beads applicable to sand grinder include balls made of glass, alumina, zircon, zirconia, steal, flint stone, and zircon or zirconia beads are preferable. Beads having particle diameter of 0.3 to 1.0 mm are preferably used in this invention though those having particle diameter of 1 to 2 mm are used usually.

Various materials such as stainless steal, nylon, ceramics may be used for a disk or inner wall of the wet type medium dispersion apparatus in general, disk or inner wall made by ceramics such as zirconia or silicone carbide are particularly preferable.

The metal oxide particles having a reactive organic group can be obtained by surface treatment employing silane compound etc., via the wet processing described above.

In addition to titanium oxide particles described above, particle oxide having reactive organic group can also be obtained employing alumina, zinc oxide, titanium oxide particles in the similar way as the titanium oxide particles, since they have hydroxy groups on the surface of the particles. The hydroxy group on the surface of the metal oxide and a compound having a silyl group form chemical bonding via hydrolysis reaction to form metal oxide particles having a reactive organic group. The reactive organic group in the silane compounds, representative examples being those of Formula (1), is bonded to the metal oxide particles by a coupling reaction with hydroxy group on the surface of the metal oxide.

The organic reactive group is bonded to the metal oxide particles via siloxane bonding, in which silicon atom is bonded through oxygen atom to the metal oxide particles. The organic reactive group such as acryloyl or methacryloyl group bonded to the metal oxide particles through siloxane bond reacts with each other or hardenable compound to form a strong layer containing the metal oxide particles.

The metal oxide particles having a reactive organic group can form a protective layer by a reaction of the metal oxide particles mutually, or the metal oxide particles having a reactive organic group can form a protective layer by a reaction of the metal oxide particles with a hardenable compound, described below, and the latter is preferable.

The hardenable compound which reacts with metal oxide particles having a reactive organic group includes various compounds having carbon-carbon double bonding, compounds having cyclic ether structure, an epoxy compound, and oxetane compound. The compound having carbon-carbon double bonding is preferable.

The hardenable compound is preferably a monomer to form resins used generally binder resin of the photoreceptor via polymerization caused by actinic ray irradiation such as ultraviolet ray r electron beams, and preferable examples include a styrene type monomer, an acryl type monomer, a methacryl type monomer, a vinyl toluene type monomer, vinyl acetate type monomer and N-vinyl pyrrolidone type monomer.

The hardenable compounds having an acryloyl or methacryloyl group are particularly preferable because they are capable of hardened with small amount of light in a short time.

The hardenable compounds may be used independently or mixing with two or more different types compounds.

Examples of the hardenable compounds are listed.

(Meth)acrylic compounds refer to compounds having either an acryloyl group (CH₂═CHCO—) or a methacryloyl group (CH₂═CCH₃CO—) in this invention. Further, number of Ac groups (number of acryloyl groups), as described herein, refers to the number of acryloyl or methacryloyl groups.

| No. | | Ac Number |
|---|---|---|
| (1) | 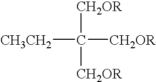 | 3 |
| (2) | 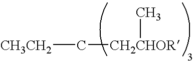 | 3 |
| (3) | 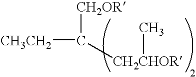 | 3 |
| (4) | 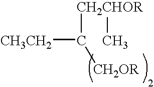 | 3 |
| (5) | 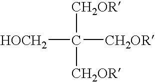 | 3 |
| (6) | 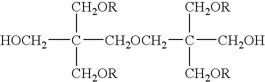 | 4 |
| (7) | 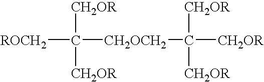 | 6 |
| (8) | 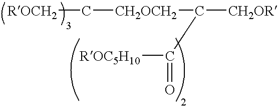 | 6 |
| (9) | 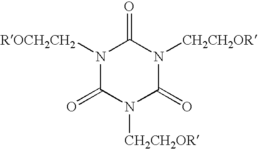 | 3 |
| (10) | 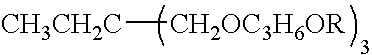 | 3 |
| (11) | 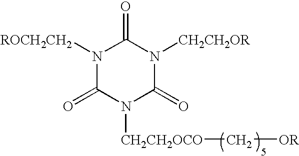 | 3 |
| (12) | 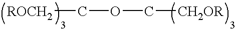 | 6 |
| (13) | 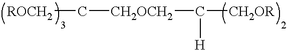 | 5 |
| (14) | 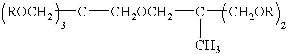 | 5 |
| (15) | 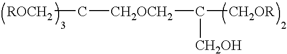 | 5 |
| (16) | 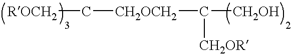 | 4 |
| (17) | 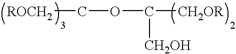 | 5 |
| (18) | 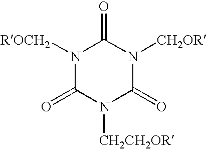 | 3 |
| (19) | 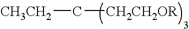 | 3 |
| (20) | 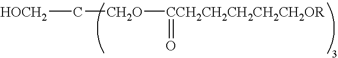 | 3 |
| (21) | 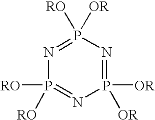 | 6 |
| (22) | 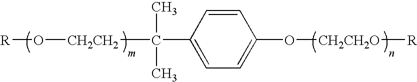 | 2 |
| (23) | 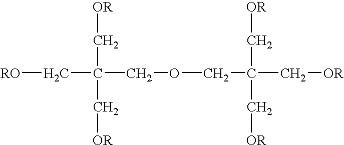 | 6 |
| (24) | 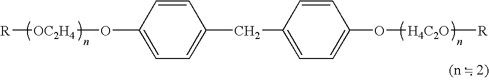 | 2 |
| (25) | 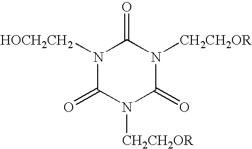 | 2 |
| (26) | 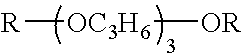 | 2 |
| (27) | 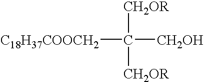 | 2 |
| (28) | 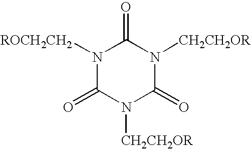 | 3 |
| (29) | 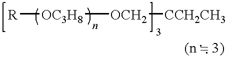 | 3 |
| (30) | 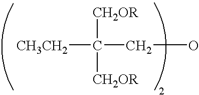 | 4 |
| (31) | 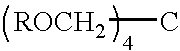 | 4 |
| (32) | 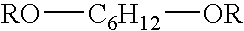 | 2 |
| (33) | 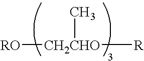 | 2 |
| (34) | 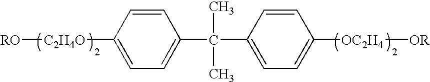 | 2 |
| (35) | 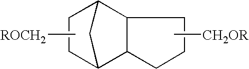 | 2 |
| (36) | 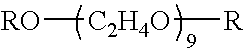 | 2 |
| (37) | 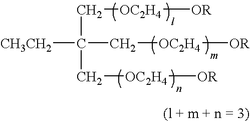 | 3 |
| (38) | 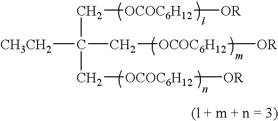 | 3 |
| (39) | 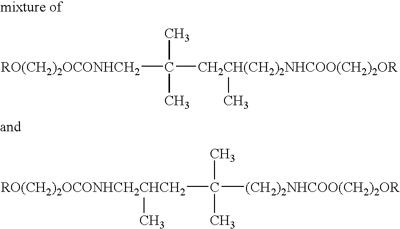 | 2 |
| (40) | 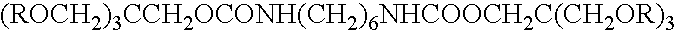 | 2 |
| (41) | 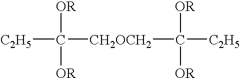 | 4 |
| (42) | 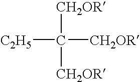 | 3 |
| (43) | 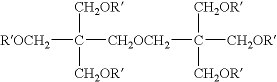 | 6 |
| (44) | 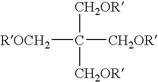 | 4 |

In the above formulae, R and R′ are each as follows:

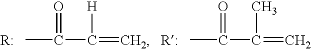

Practical examples of the preferable oxetane compounds are listed.

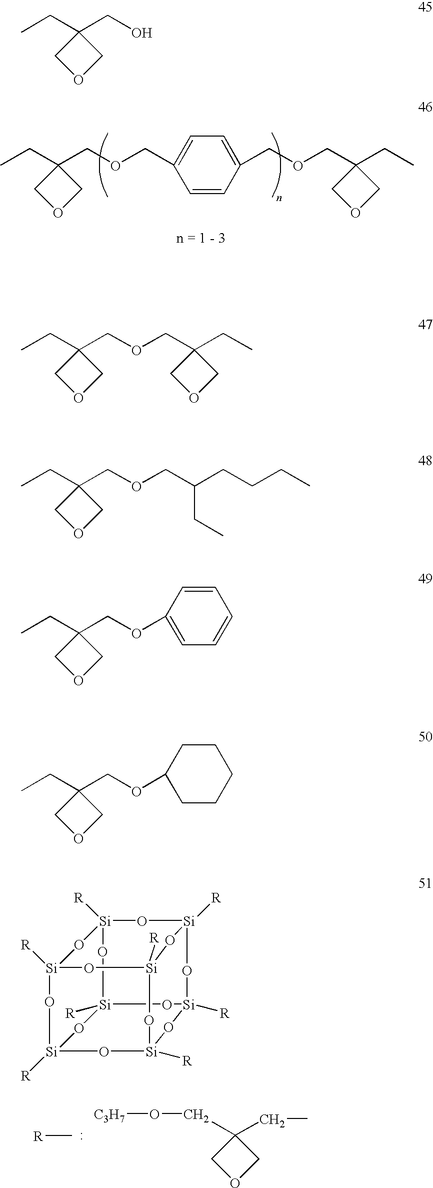

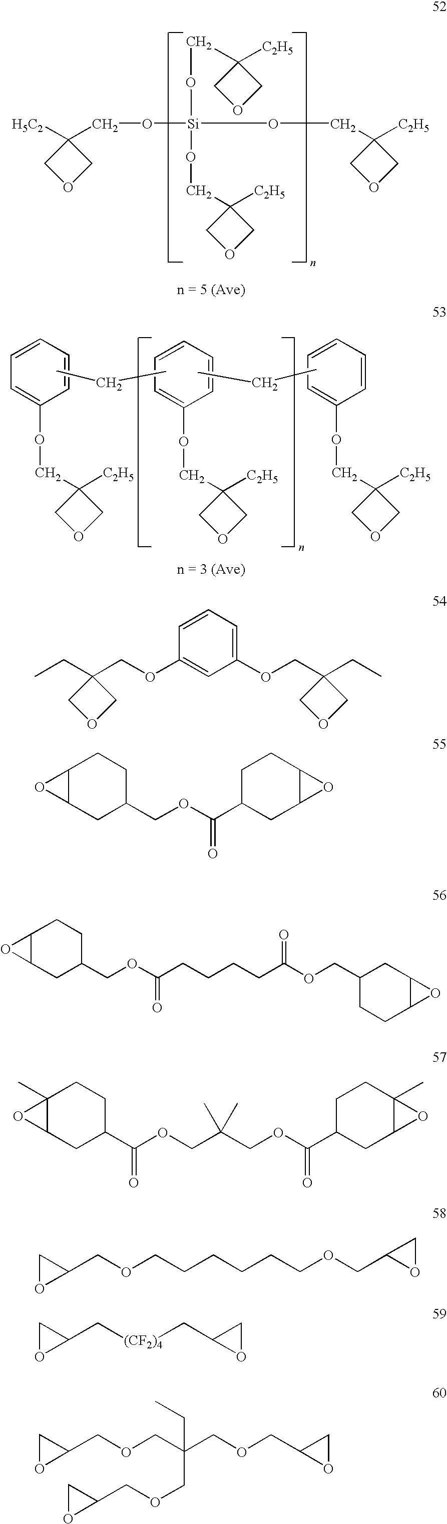

The epoxy compounds include an aromatic epoxide, an alicyclic epoxide and aliphatic epoxide.

The hardenable compounds preferably have two or more functional groups, and more preferably four or more functional groups in particular. It is preferred that a ratio of Ac/M has preferably the following condition, wherein Ac and M are a number of acryloyl or methacryloyl group and molecular weight, respectively, of the compound having a acryloyl or methacryloyl group when the hardenable compound is an acryl type compound. High crosslinking density is obtained and improved anti-abrasion property of the photoreceptor is obtained by satisfying the relation.

0.005<Ac/M<0.012

### Metal Oxide Particles

The metal oxide particles include particles of magnesium oxide, zinc oxide, lead oxide, aluminum oxide, tantalum oxide, indium oxide, bismuth oxide, yttrium oxide, cobalt oxide, copper oxide, manganese oxide, selenium oxide, iron oxide, zirconium oxide, germanium oxide, tin oxide, titanium oxide, niobium oxide, molybdenum oxide, vanadium oxide, and preferable examples are particles of titanium oxide, alumina zinc oxide and tin oxide.

The metal oxide particles may be manufactured by a conventional method such as a gas phase method, a chlorine method, a sulfuric acid method, a plasma method and electrolytic method.

A number average primary particle diameter of the metal oxide particles is preferably 1-300 nm, and more preferably 3-100 nm. Anti-abrasion property is not sufficient in case of smaller particle diameter, and there may be possibility that exposure light may be scattered or anti-abrasion property becomes insufficient as the particles inhibit photo-curing.

The number average primary particle diameter of the metal oxide particles is obtained by a method in which photograph of magnification factor of 10,000 times is taken via scanning electro-microscopy (manufactured by JEOL Ltd.) and randomly selected 300 particles, excluding aggregated particles, are read in by a scanner. Number average particle diameter is calculated by an automatic image processor LUZEX AP, manufactured by Nireco Corporation, with software ver. 1.32.

Content of the metal oxide particles in the protective layer is preferably 5 to 95% by weight, and more preferably 10-80% by weight with reference to whole solid component of the protective layer.

Anti-oxidant used in this invention is described.

The protective layer comprises an anti-oxidant in combination with the compounds composed of the hardenable compound, the metal oxide particles having a reactive organic group.

The anti-oxidant used in this invention removes residual radical generated by light or heat during the manufacturing process of the organic photoreceptor, or prevents reaction of unreacted radical functional group, and further inhibits surface stain such as decomposition or denaturing caused by ozone gas or nitrogen oxides generated during the repeated image forming in the image forming apparatus. This advantage is particularly effective when the reactive organic group of the metal oxide particles is a radical polymerizable group. It is estimated that the anti-oxidant works to retard reaction in a radical polymerization reaction since it functions as a radical capture, and therefore, reaction between the metal oxide particles in the neighborhood of the particles or excess reaction rate between the particles and the reactive compound are prevented, whereby a protective layer containing compounds having flexibility balanced with mechanical strength is formed. Consequently the strength of the surface of the photoreceptor against abrasion or rubbing is remarkably improved, damage of surface, abrasion wastage, image blur formed in a condition at high temperature and high humidity are remarkably improved.

The antioxidants are compounds having a function of preventing or inhibiting an action of oxygen against autoxidation substance within or on the surface of the photoreceptor in circumstances of light, heat discharge and so on. The following compounds are exemplified.

### (1) Radical Chain Inhibitor

Phenol type antioxidant (Hindered phenols)
Amine type antioxidant (Hindered amines, diallyl diamines, and diallyl amines)
Hydroquinone type antioxidant

### (2) Peroxide Decomposer

Sulfur type antioxidant (Thioethers)
Phosphor type antioxidant (Phosphorous esters)

Radical chain inhibitor is preferably employed among compounds referred above. Hindered phenols and hindered amines antioxidants are particularly preferable. Two or more species of the compounds, for example, a combination of a hindered phenol antioxidant and a thioether antioxidant, may be employed. The antioxidants having a partial structure of hindered phenol, hindered amine in a molecule may be employed.

The anti-oxidant generally inhibits radical polymerization, and therefore, it is not commonly used for a composition to polymerize. The anti-oxidant of this invention is added to a composition for forming the protective layer containing metal oxide particles having a reactive organic group and optionally a hardenable compound having carbon-carbon double bond, then the composition is coated and subjected to polymerization reaction. The reactive organic groups on the metal oxide particles react with each other or with the hardenable compound in the presence of the anti-oxidant to form polymer including metal oxide particles. The inventors found that in case that the polymerization is conducted in the presence of the anti-oxidant among the metal oxide particles having reactive organic groups (and optionally a hardenable compound), closer and higher density layer is formed.

Radical chain inhibitor type anti-oxidant is particularly preferable by this reason.

Particularly hindered phenol and hindered amine antioxidants are effective for such improvement of preventing occurrence of fogging and density reduction at the end portion of image in high temperature and high moisture condition, further they are effective to depress generation of image blur, surface damage and abrasion of the protective layer.

Content of the antioxidant such as hindered phenol or hindered amine is preferably 0.01 to 20 weight % in the protective layer. It is liable to generate fog or spots when less than 0.01%, and it is liable to generate reduction of transport ability in the protective layer resulting increase of residual potential, reduction of anti-abrasion ability due to inhibition of polymerization reaction and decreasing image density, and to generate decrease of film intensity resulting occurrence of streak damage.

The hindered phenols means compounds having a branched alkyl group in the ortho position relative to the hydroxyl group of a phenol compound and derivatives thereof. The hydroxyl group may be modified to an alkoxy group.

The hindered amines are compounds having a bulky organic group in the neighborhood of a nitrogen atom, wherein an example of the bulky organic group is a branched alkyl group, and for example t-butyl is preferable. Listed as hindered amines are compounds having an organic group represented by the following structural formula:

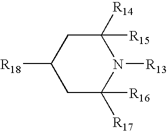

wherein R₁₃ represents a hydrogen atom or a univalent organic group, R₁₄, R₁₅, R₁₆ and R₁₇ each represents an alkyl group, and R₁₈ represents a hydrogen atom, a hydroxyl group, or a monovalent organic group.

Examples of the antioxidants having a partial hindered phenol structure include compounds described in JP A H01-118137 (on pages 7 to 14).

Examples of the antioxidants having a partial hindered amine structure include compounds described in JP A H01-118138 (on pages 7 to 9).

Examples of organic phosphor compounds are those represented by a formula of RO—P(OR)—OR, wherein R is a hydrogen atom, an alkyl, alkenyl or aryl group which may have a substituent.

Examples of organic sulfur compounds are those represented by a formula of R—S—OR, wherein R is a hydrogen atom, an alkyl, alkenyl or aryl group which may have a substituent.

Representative antioxidants are listed.

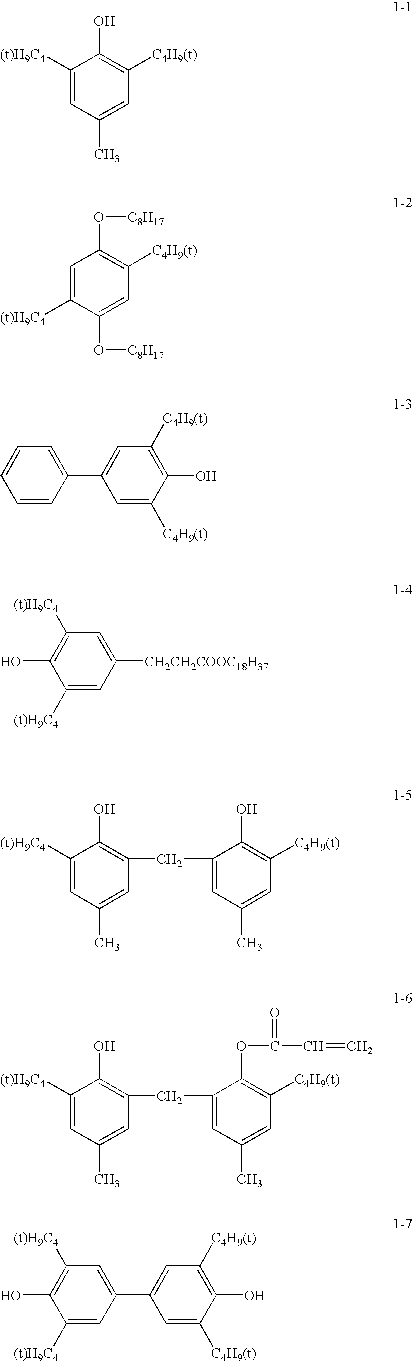

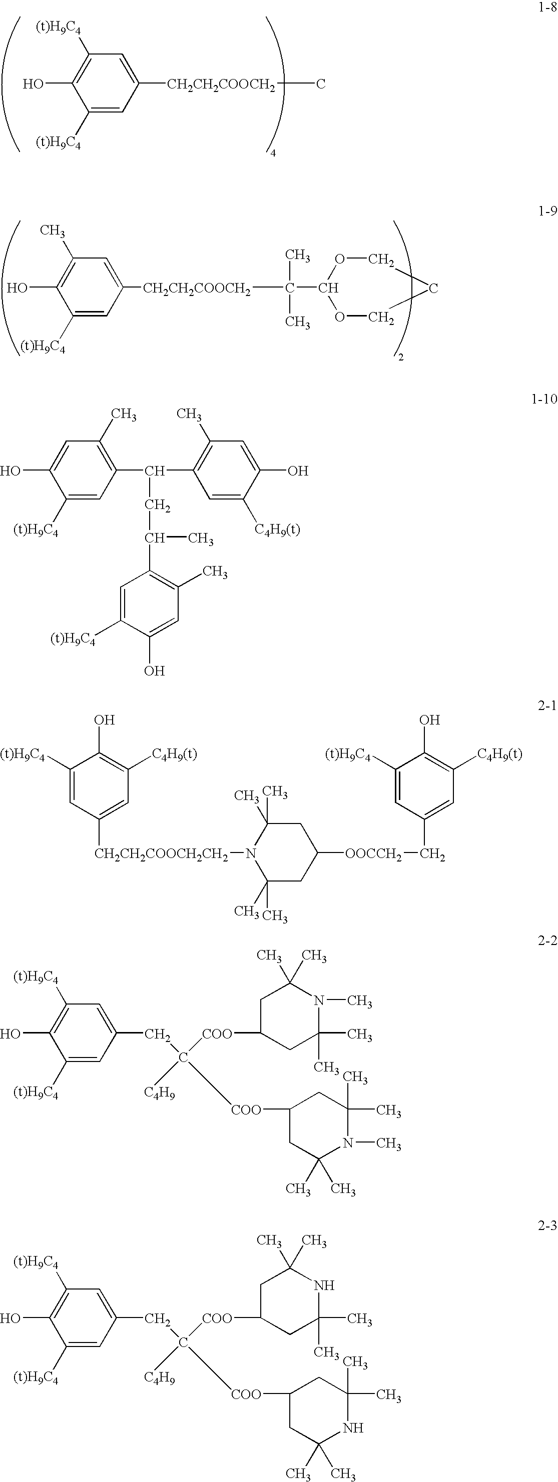

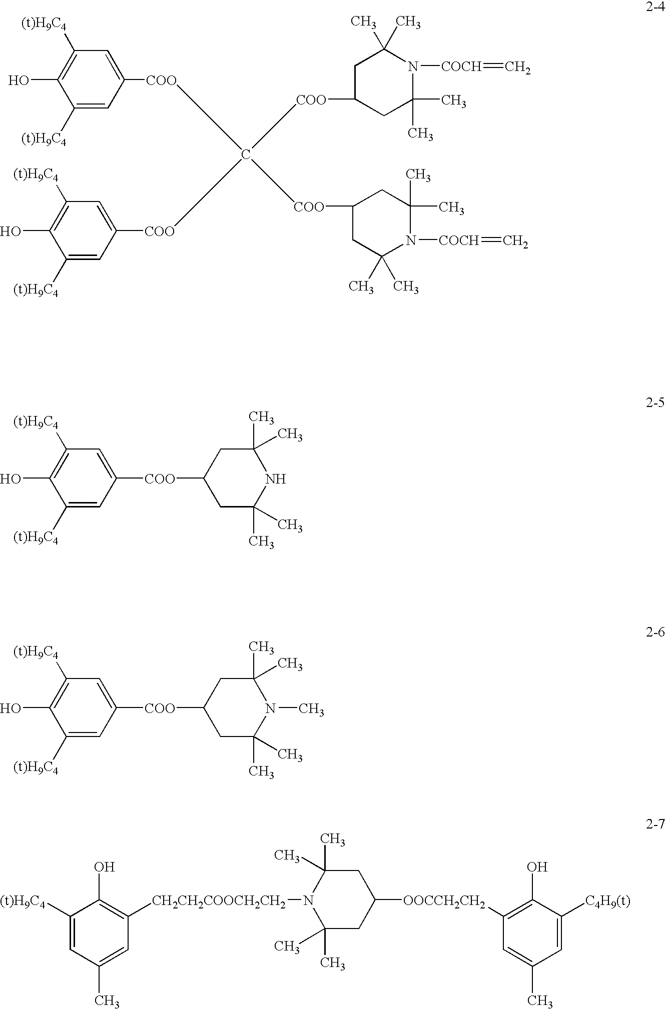

Examples of antioxidant available on the market include the followings.

Hindered phenol type antioxidant: IRGANOX 1076, IRGANOX 1010, IRGANOX 1098, IRGANOX 245, IRGANOX 1330, and IRGANOX 3114.

Hindered amine type antioxidant: Sanol LS2626, Sanol LS765, Sanol LS770, Sanol LS744, Tinuvin 144, Tinuvin 622LD, Mark LA57, Mark LA67, Mark LA62, Mark LA68 and Mark LA63.

Thioether type antioxidant: Sumilizer TPS and Sumilizer TP-D.

Phosphite type antioxidant: Mark 2112, MarkPEP-8, MarkPEP-24G, MarkPEP-36 Mark 329K and Mark HP-10.

In a reaction of metal oxide particles having a reactive organic group or hardenable compounds, a method reacting initiated electron beam cleavage, a method reacting by light or heat via adding radical polymerization initiator or cation polymerization initiator. A light polymerization initiator or a heat polymerization initiator may be employed. The light and heat polymerization initiators are employed in combination.

Light polymerization initiator is preferable for the radical polymerization initiator of the hardenable compounds. Alkyl phenone type compounds and phosphine oxide type compounds are preferable among them. Compounds having α-hydroxy acetophenone structure or acylphosphine oxide structure are particularly preferable. Ion type polymerization initiators composed of aromatic onium compound of diazonium, ammonium, iodonium, sulfonium, and phosphonium of B(C₆F₅)₄⁻, PF₆⁻, AsF₆⁻, SbF₆⁻ and CF₃SO₃⁻, or nonion type polymerization initiators such as sulfone compound generating sulfonic acid, halogen compounds generating hydrogen halides, or iron arene complex compounds to initiate cation polymerization. Particularly the nonion type initiators of the sulfone compound generating sulfonic acid and the halogen compounds generating hydrogen halides are preferable.

Compound examples of the photopolymerization initiators used in the present invention will now be listed.

### Examples of α-Aminoacetophenone Type Compounds:

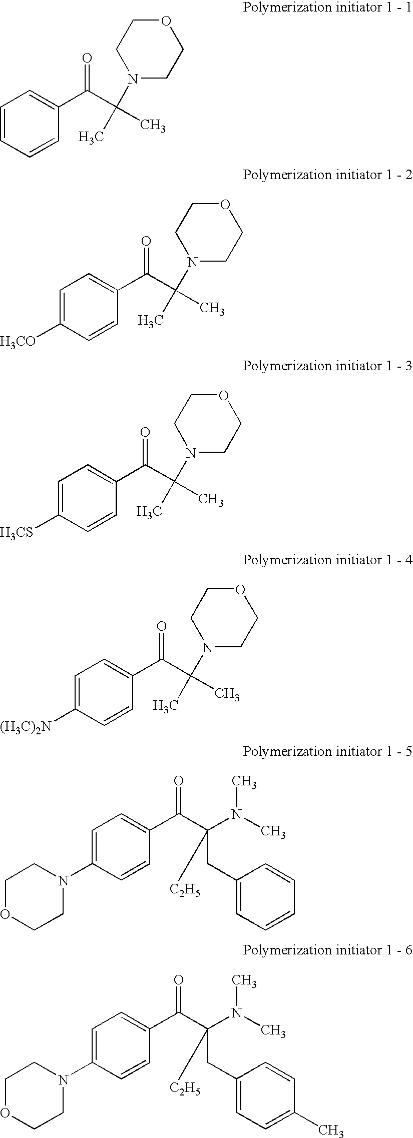

### Examples of α-Hydroxyacetophenone Type Compounds:

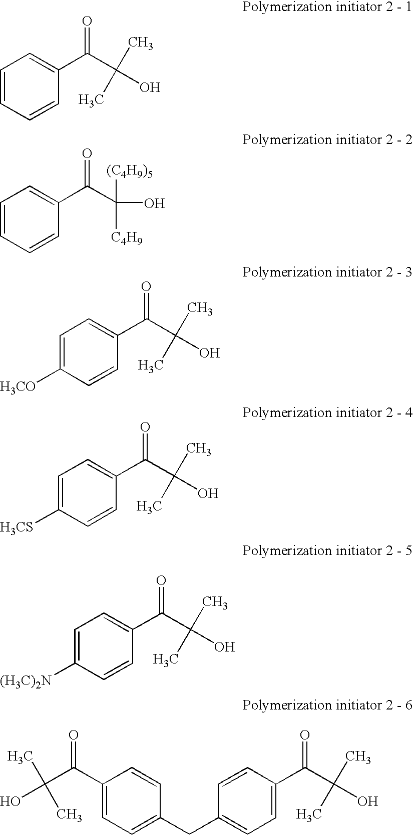

### Examples of Acylphosphine Oxide Type Compounds:

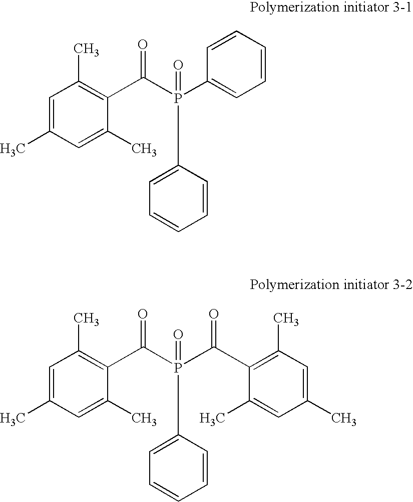

### Examples of Other Radical Type Polymerization Initiator:

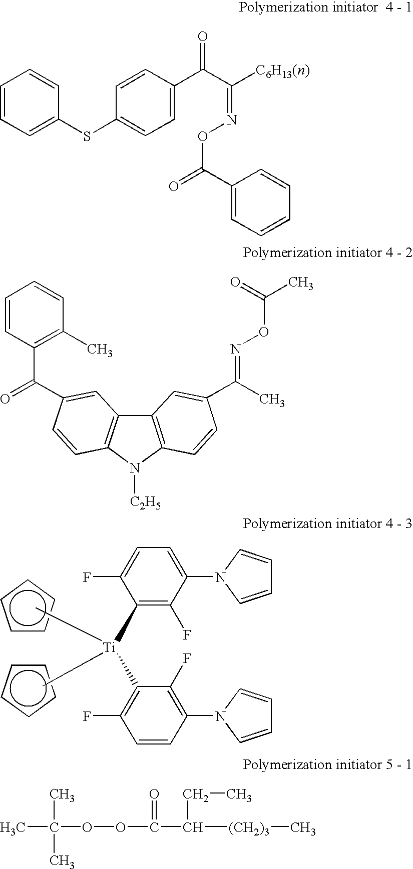

### Examples of Nonion Type Polymerization Initiator:

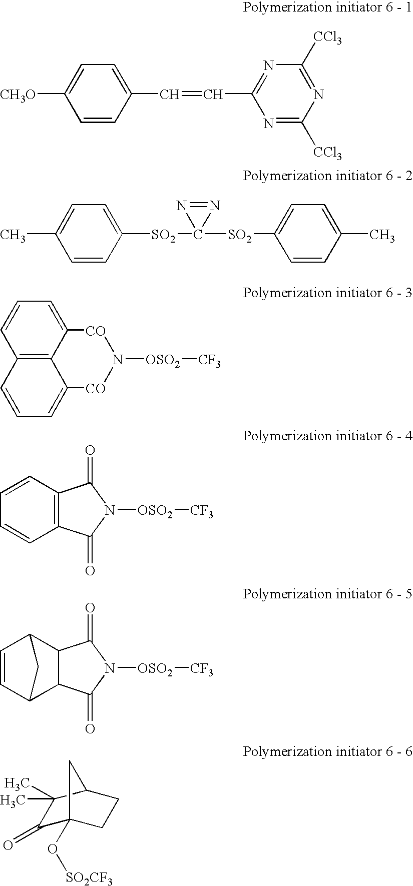

### Examples of Ionic Type Polymerization Initiator:

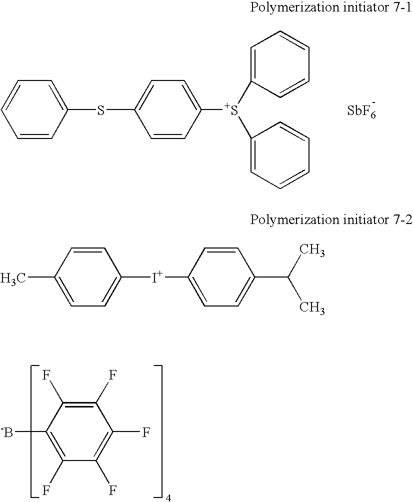

It is preferably that the protective layer of the present invention is subjected to natural drying or heat drying after having been coated, then the protective layer is made to react by exposure to actinic radiation or by heating. It is also preferred that the reaction is made in the presence of an anti-oxidant.

Similarly to the case of the intermediate layer or photosensitive layer, the protective layer can be coated according to such methods as dip coating, spray coating, spinner coating, bead coating, blade coating, beam coating, and slide hopper coating methods.

For the photoreceptor of the present invention, the following step is preferably used: Actinic radiation is applied to a coating layer to generate radicals and cause polymerization. Intermolecular and intramolecular crosslinking is formed by a crosslinking reaction, and curing is performed to generate a cured resin. It is preferred in particular to use an ultraviolet ray and electron beam as actinic radiation.

There is no particular restriction to the ultraviolet light source if ultraviolet rays can be emitted. It is possible to use a low pressure mercury lamp, intermediate pressure mercury lamp, high pressure mercury lamp, extra-high pressure mercury lamp, carbon arc lamp, metal halide lamp, xenon lamp, flash or pulse xenon and others. Irradiation conditions differ according to each lamp. The dose of actinic radiation is normally in the range of 5 to 500 mJ/cm², preferably in the range of 5 to 100 mJ/cm². The electric power of the lamp is preferably in the range of 0.1 kW through 5 kW, more preferably in the range of 0.5 kW through 3 kW.

There is no restriction to the electron beam irradiation apparatus as the electron beam source. Generally, a curtain beam type that produces high power at less costs is effectively used as an electron beam accelerator for emitting the electron beam. The acceleration voltage at the time of electron beam irradiation is preferably in the range of 100 through 300 kV. The absorbed dose is preferably kept in the range of 0.5 through 10 Mrad.

The irradiation time to get the required dose of actinic radiation is preferably 0.1 sec to 10 min., and is more preferably 0.1 sec to 5 min.

Ultraviolet rays are easy to use as actinic radiation, and are preferably used.

The protective layer of the photoreceptor can be dried before and during irradiation with actinic radiation. Appropriate timing for drying can be selected by a combination thereof.

Appropriate drying conditions can be selected according to the type of solvent and film thickness. The drying temperature is preferably from the room temperature to 180° C., more preferably from 80° C. to 140° C. Drying time is preferably 1 min to 200 min, more preferably 5 min to 100 min.

The film thickness of the protective layer is preferably in the range of 0.2 through 10 μm, more preferably in the range of 0.5 through 6 μm.

The composition of the organic photoreceptor other than the surface layer will be described.

The organic photoreceptor of this invention comprises a photosensitive layer provided on a support and the protective layer provides thereon. An Intermediate Layer may be provided. The photosensitive layer includes a charge generation layer and a charge transfer layer. At least one of a charge generation function transfer function in the charge transfer layer is relied on an organic material.

The organic photoreceptor of this invention comprises, on an electroconductive substrate, the photosensitive layer and the protective layer provided thereon. The organic photoreceptor will be described more in detail. The representative photoreceptors include:

(1) A photoreceptor having an interlayer provided on an electroconductive support, a charge generation layer and charge transport layer as the photosensitive layer, and a protective layer in this order, and
(2) A photoreceptor having an interlayer provided on an electroconductive support, a photosensitive layer containing a charge generation material and a charge transport material, and a protective layer, in this order.

The photoreceptor is described taking the above (1) type as an example.

### Conductive Support

There is no restriction to the support used in the present invention if it is conductive. The examples are:

a drum or a sheet formed of such a metal as aluminum, copper, chromium, nickel, zinc and stainless steel;

a plastic film laminated with such a metal foil as aluminum and copper;

a plastic film provided with vapor deposition of aluminum, indium oxide, and tin oxide; and

a metal, plastic film, or paper provided with a conductive layer by coating a conductive substance independently or in combination with a binder resin.

### Intermediate Layer

An intermediate layer having a barrier function and adhesion function can be provided between the conductive layer and a photosensitive layer in the present invention.

To form the intermediate layer, such a binder resin as casein, polyvinyl alcohol, nitrocellulose, ethylene-acrylic acid copolymer, polyamide, polyurethane or gelatin is dissolved in the commonly known solvent, and the intermediate layer can be formed by dip coating. Of these materials, alcohol soluble polyamide resin is preferably used.

Various types of conductive fine particles and metallic oxides can be added to adjust the resistance of the intermediate layer. Examples are such metallic oxides as alumina, zinc oxide, titanium oxide, tin oxide, antimony oxide, indium oxide, and bismuth oxide. Examples also include extra-fine particles of tin-doped indium oxide, antimony-doped tin oxide, and antimony-doped zirconium oxide.

These metallic oxides each can be used independently or two or more of them can be used in combination. When two or more of them are used in combination, they can be used in the form of a solid solution or a fused substance. The preferred average particle size of such metallic oxide is preferably 0.3 μm or less, more preferably 0.1 μm or less.

The solvent used for preparation of the intermediate layer is preferably capable of effective dispersion of inorganic particles and dissolution of polyamide resin. The preferred solvent is exemplified by alcohols containing 2 through 4 carbon atoms such as ethanol, n-propyl alcohol, isopropyl alcohol, n-butanol, t-butanol, and sec-butanol having excellent polyamide resin dissolution and coating performances. Further, to improve the storage ability and particle dispersion, it is possible to use an auxiliary solvent providing excellent effects when used in combination with the aforementioned solvent. The examples of such an auxiliary solvent are methanol, benzyl alcohol, toluene, methylene chloride, cyclohexane, and tetrahydrofuran.

The concentration of the binder resin is selected as appropriate in conformity to the film thickness of the intermediate layer and production speed.

When inorganic particles are dispersed in the binder resin, the amount of the mixed inorganic resin is preferably in the range of 20 through 400 parts by weight, more preferably in the range of 50 through 200 parts by weight, with respect to 100 parts by weight of the binder resin.

An ultrasonic homogenizer, ball mill, sand grinder, and homomixer can be used to disperse the inorganic particles.

The method of drying the intermediate layer can be selected as appropriate in conformity to the type of solvent and film thickness. The method of drying by heat is preferably used.

The film thickness of the intermediate layer is preferably 0.1 to 15 μm, more preferably 0.3 through 10 μm.

### Electric Charge Generation Layer

The electric charge generation layer used in the present invention is preferably a layer that contains an electric charge generation material and a binder resin, and is formed by dispersing the electric charge generation material in the binder resin solution, and coating the same.

The electric charge generation material is exemplified by an azo material such as Sudan Red and Diane Blue; quinone pigment such as pyrene quinone and anthanthrone; quinocyanine pigment; perylene pigment; indigo pigment such as indigo, and thioindigo; and phthalocyanine pigment. These electric charge generation materials can be used independently or in the form dispersed in the resin.

The conventional resin can be used as the binder resin of the electric charge generation layer. Such a resin is exemplified by polystyrene resin, polyethylene resin, polypropylene resin, acryl resin, methacryl resin, vinyl chloride resin, vinyl acetate resin, polyvinyl butyral resin, epoxy resin, polyurethane resin, phenol resin, polyester resin, alkyd resin, polycarbonate resin, silicone resin, melamine resin, copolymer resin containing two or more of these resins (e.g., vinyl chloride-vinyl acetate copolymer, vinyl chloride-vinyl acetate-anhydrous maleic acid copolymer), and polyvinyl carbazole resin.

The electric charge generation layer is preferably formed as follows: The electric charge generation material is dispersed by a homogenizer into solution obtained by dissolving a binder resin in solvent, whereby a coating composition is prepared. Then the coating composition is coated to a predetermined thickness using a coating device. After that, the coated film is dried, whereby the electric charge generation layer is formed.

The examples of the solvent used for dissolving the binder resin used for preparing the electric charge generation layer and coating include toluene, xylene, methylene chloride, 1,2-dichloroethane, methyl ethyl ketone, cyclohexane, ethyl acetate, butyl acetate, methanol, ethanol, propanol, butanol, methyl cellosolve, ethyl cellosolve, tetrahydrofuran, 1-dioxane, 1,3-dioxolane, pyridine and diethyl amine.

An ultrasonic homogenizer, ball mill, sand grinder, and homomixer can be used to disperse the electric charge generation material.

The amount of the electric charge generation material is preferably 1 through 600 parts by weight of the electric charge generation material, more preferably 50 through 500, with respect to 100 parts by weight of binder resin. The film thickness of the electric charge generation layer differs according to the characteristics of the electric charge generation material and binder resin and percentage of mixture, and is preferably 0.01 through 5 μm, more preferably 0.05 through 3 μm. An image defect can be prevented from occurring by filtering out the foreign substances and coagulants before applying the coating composition for the electric charge generation layer. It can be formed by vacuum evaporation coating of the aforementioned pigment.

### Electric Charge Transport Layer

The electric charge transport layer used in the photosensitive layer contains an electric charge transport material and binder resin, and is formed by dissolving the electric charge transport material in the binder resin and coating the same.

The electric charge transport material is exemplified by carbazole derivatives, oxazole derivatives, oxadiazole derivatives, triazole derivatives, thiadiazole derivatives, triazole derivatives, imidazole derivatives, imidazolone derivatives, imidazolidine derivatives, bisimidazolidine derivatives, styryl compound, hydrazone compound, pyrazoline compound, oxazolone derivatives, benzimidazole derivatives, quinazoline derivatives, benzofuran derivatives, acridine derivatives, phenazine derivatives, aminostilbene derivatives, triarylamine derivatives, phenylene diamine derivatives, stilbene derivatives, benzidine derivatives, poly-N-vinyl carbazole, poly-1-vinyl pyrene, and poly-9-vinyl anthracene. Two or more of these substances can be mixed for use.

The conventional resin can be used as the binder resin for the electric charge transport layer. The examples include polycarbonate resin, polyacrylate resin, polyester resin, polystyrene resin, styrene-acrylonitrile copolymer resin, polymethacrylate ester resin, and styrene-methacrylate ester copolymer. Polycarbonate is preferably used. Further, BPA (Bisphenol A), BPZ, dimethyl EPA, and BPA-dimethyl BPA copolymers are preferably used because of excellent resistance to cracks and abrasion, and superb antistatic performances.

The electric charge transport layer is preferably formed by dissolving binder resin and an electric charge transport material to prepare a coating composition, which is then applied to the layer to a predetermined thickness. Then the coating film is dried.

The examples of the solvent for dissolving the binder resin and electric charge transport materials include toluene, xylene, methylene chloride, 1,2-dichloroethane, methyl ethyl ketone, cyclohexane, ethyl acetate, butyl acetate, methanol, ethanol, propanol, butanol, tetrahydrofuran, 1,4-dioxane, 1,3-dioxolane, pyridine, and diethyl amine, without being restricted thereto.

The amount of electric charge transport material is preferably in the range of 10 through 500 parts by weight of electric charge transport material, more preferably in the range of 20 through 100 parts by weight, with respect to 100 parts by weight of binder resin.

The thickness of the electric charge transport layer varies according to the characteristics of the electric charge transport material and binder resin, and percentage of mixture, and is preferably 5 through 40 μm, more preferably 10 through 30 μm.

An antioxidant, electronic conductive agent, and stabilizer can be applied to the electric charge transport layer. The antioxidants listed in JP-A 2000-305291, and electronic conductive agents listed in JP-A S50-137543 and S58-76483 are preferably used.

A latent image formed on the photoreceptor is visualized to a toner image via development. The toner used in the development includes pulverized toner or polymerization toner, and polymerization toner is preferable because stable particle size distribution is obtained.

In the polymerization toner, preparation of binder resin for the toner and the shape of toner particles are formed by a polymerization of monomer of the binder resin material and, if necessary, a chemical process thereafter. Practically, the toner is prepared by polymerization such as suspension polymerization or emulsion polymerization and a process of fusing particles after the polymerization.

Volume average particle diameter of the toner, i.e. 50% volume particle (Dv 50), is preferably 2 to 9 μm, and more preferably 3 to 7 μm. High resolution of the image is obtained by employing toner having such particle size distribution condition. Further, the toner can be composed of reduced content of minute particle size though the toner is small particle size toner, and color reproduction of dot image is improved for long time and toner image having good sharpness and stability can be obtained.

### Developer

The toner of the present invention can be used in the form of a one-component developer and two-component developer.

The one-component developer to be used includes the non-magnetic one-component developer and the magnetic one-component developer formed by about 0.1 μm through 0.5 μm of magnetic particles contained in the toner. Both of them can be used.

The developer can be mixed with a carrier and can be used as a two-component developer. Examples of the carrier are conventional magnetic particles as exemplified by metals such as iron, ferrite and magnetite, and alloys between these metals and such metals as aluminum and lead. Use of the ferrite particles is preferred in particular. The particle size of the aforementioned carrier is preferably 15 through 100 μm in terms of mass-average particle size, more preferably 25 through 80 μm.

The carrier particle size can be measured typically by the laser diffraction type particle size distribution measuring instrument “Helos” (by Sympatec Inc.).

The preferred carrier is the one whose magnetic particles are coated further with resin, or the so-called resin dispersed carrier wherein magnetic particles are dispersed in resin. There is no particular restriction to the type of the resin for coating. For example, olefin resin, styrene resin, styrene-acrylic resin, silicone resin, ester resin, or fluorine-containing polymer resin are often used. Further, there is no particular restriction to the type of the resins for constituting the resin dispersed carrier. The conventionally known resins can be used. Examples are styrene-acrylic resin, polyester resin, fluorine resin, and phenol resin. The carrier coated with styrene-acrylic resin out of these examples is preferably used because of the excellent performances in preventing the external additive agent from being separated, or in enhancing durability.

An image forming apparatus to which the organic photoreceptor of the present invention may be applied is described.

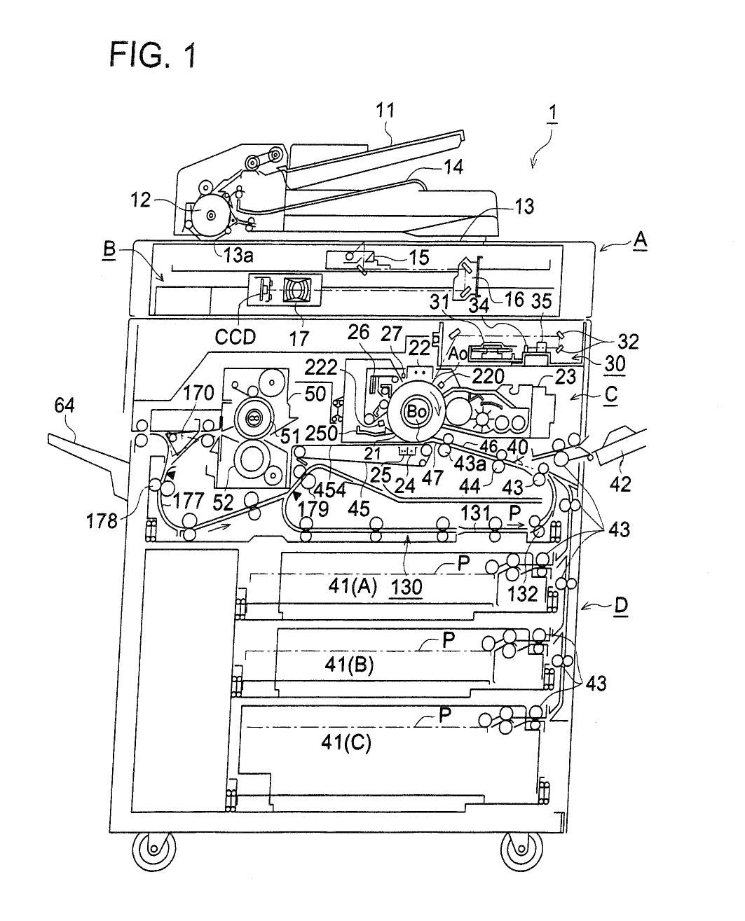

The image forming apparatus 1 shown in FIG. 1 is a digital type image forming apparatus, and is structured by an image reading section A, image processing section B (not shown), image forming section C, and transfer sheet conveyance section D.

An automatic document feeding unit to automatically convey documents is provided on the upper portion of the image reading section A, and the documents placed on a document placement board 11 is separated one by one sheet and conveyed by a document conveyance roller 12, and an image is read at a reading position 13a. The document whose reading is completed, is delivered by the document conveyance roller 12 onto a document sheet delivery tray 14.

An image of the document when it is placed on a platen glass 13, is read out by a reading operation at a speed of v of the first mirror unit 15 which is composed of an illumination lamp and the first mirror, and by a moving exposure at a speed of v/2 of the second mirror unit 16 in the same direction which is composed of the second mirror and the third mirror, which are positioned in V-letter shape, wherein the first mirror unit 15 and the second mirror unit constitute a scanning optical system.

The read image is formed on the light receiving surface of an image pick-up element CCD, which is a line sensor, through a projection lens 17. A line-shaped optical image formed on the image pick-up element CCD is successively electro-optical converted into electrical signal (brightness signal), then A/D converted, and after processing such as density conversion, filter processing, or the like, is conducted in an image processing section B, the image data is temporarily stored in a memory.

In the image forming section C, as image forming units, around the outer periphery of a drum-like photoreceptor 21, a charger 22 to charge on the photoreceptor, a potential detecting device 220 to detect the potential on the photoreceptor, a developing unit 23, a transfer belt 45, a cleaning unit 26 cleaning the photoreceptor, and pre-charge lamp (PCL) 27 eliminating potential by light on the photoreceptor are respectively arranged in the order of operation. A reflective density meter 222, which measures reflective density of developed patch image, is equipped on the photoreceptor at the down stream of the developer 23. The photoreceptor drum 21 according to this invention is rotated clockwise in the drawing.

After uniform charging by the charger 22 is conducted on the rotating the photoreceptor 21, image exposure is conducted by the exposure optical system 30 according to an image signal read from the memory of the image processing section B. The exposure optical system 30, which is a writing unit, uses a laser diode, not shown, as a light emitting source, and an optical path is changed by a reflection mirror 32 through a rotating polygonal mirror 31, fθ lens 34, and cylindrical lens (no numeric code), and the primary scanning is conducted. The image exposure is conducted at position A0 on the photoreceptor drum 21, and a latent image is formed by the rotation (the subsidiary scanning) of the photoreceptor drum 21. In the present example, exposure is conducted on a portion having characters and a reversal latent image is formed.

A semiconductor laser or an emission diode having oscillation wave length of 350-500 nm is employed for image exposure to form a latent image on the photoreceptor in this invention. An electrophotographic image having 600-2,500 dpi high definition can be obtained by employing these exposing light source with exposing laser light beam spot of 10-50 μm in the primary scanning direction and exposing digitally.

The laser light beam spot is a radius of a length of exposing beam (Ld) measured at the maximum position along with a primary scanning direction in an area having exposing intensity of more than 1/e² times of peak intensity of the exposing light beam.

Image exposure is conducted by light beam employing a scanning optical system such as semiconductor laser, and a solid scanner such as LED and liquid crystal shutter. The light beam intensity distribution includes Gaussian, Lorentzian and so on, in any which the light beam spot mentioned above may be applied.

The latent image on the photoreceptor drum 21 is reversal-developed by the developing unit 23, and a visual image by a toner is formed on a surface of the photoreceptor drum 21.

In the transfer sheet conveyance section D, sheet feed units 41 (A), 41(B), and 41(C) in which different sized transfer sheet P are accommodated, are provided in the lower portion of the image forming unit, and on the side portion, a manual sheet feed unit 42 to conduct the manual sheet feed is provided, and the transfer sheet selected from any one of these sheet feed units, is fed along a sheet feed path 40 by a guiding roller 43. The transfer sheet P is temporarily stopped and then fed by the register roller 44 by which inclination and deflection of the feeding transfer sheet are corrected, and through a sheet feed path 40, a pre-transfer roller 43a, a paper providing pass 46 and entrance guide plate 47, the toner image on the photoreceptor drum 21 is transferred onto the transfer sheet P at the transfer position BO by the transfer unit 24, next, the transfer sheet P is discharged by the separation unit 25 and claw separator 250 and separated from the photoreceptor drum 21 surface, and conveyed to the fixing unit 50 by the conveyance apparatus 45.

The fixing unit 50 has a fixing roller 51 and a pressure roller 52, and the transfer sheet passes between the fixing roller 51 and the pressure roller 52, thereby, toner is fused by heat and pressure. On the transfer sheet P on one side of which the toner image has been fixed, two-sided image formation, by which the toner image is formed also on the other side of the transfer sheet, is conducted according to a mode, which will be described below, or on the condition that the image is formed on only one side of the transfer sheet, the transfer sheet is delivered onto the sheet delivery tray 64.

The situation for image forming on one side of the image receiving sheet is described above. When the copies are made on both sides of the sheet, the paper outputting course changing member 170 is switched so that the image receiving paper guiding member 177 is opened and the image receiving paper P is conveyed in the direction of the broken arrow.

The image receiving paper P is conveyed to the lower direction by a conveying mechanism 178 and switch-backed, so as to become the tail of the paper to top, and guided into a paper supplying unit for double-face copying 130.

The image receiving paper P is conveyed to paper supplying direction on the conveying guide 131 provided in the paper supplying unit for double-face copying 130 and re-supplied by the paper supplying roller 132 and guided to the conveying course 40.

The image receiving paper P is conveyed to the photoreceptor 21 as above-mentioned and a toner image is transferred onto the back side of the image receiving paper P, and output onto the paper output tray 64 after fixing the toner image by the fixing unit 50.

In the image forming method according to the invention, the photoreceptor and another constituting member such as the developing unit and the cleaning unit may be combined as a unit of a processing cartridge which can be freely installed to and released from the main body of the apparatus. Besides, at least one of the charging unit, imagewise exposing unit, developing unit, transferring or separating unit and cleaning unit may be unitized with the photoreceptor to form a processing cartridge which is able to be freely installed to or released from the main body of the apparatus using a guiding means such as a rail.

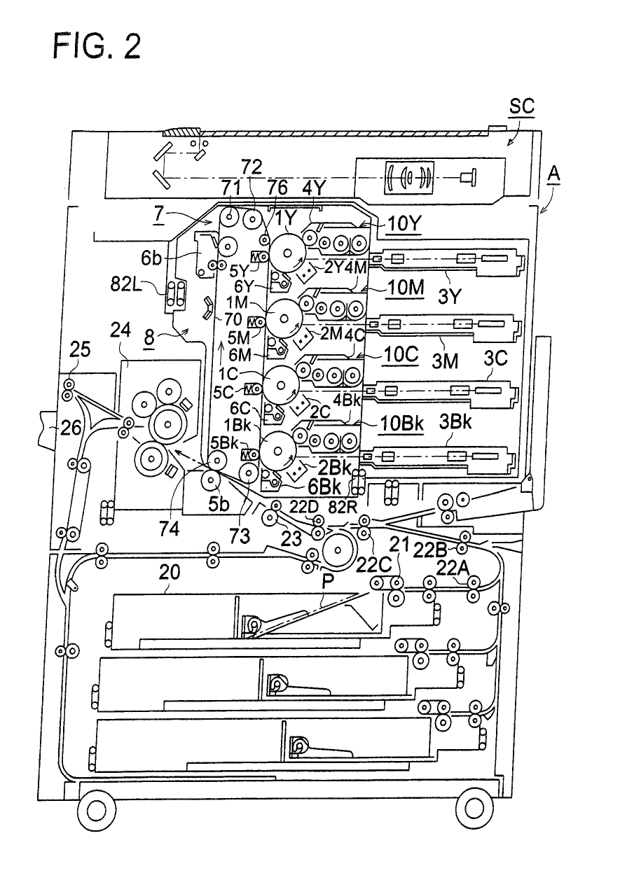

FIG. 2 is a schematic view of an example of a color image forming apparatus.

The color image forming apparatus is one so called as a tandem type color image forming apparatus, in which plural image forming units 10Y, 10M, 10C and 10Bk, an endless belt-shaped intermediate transferring unit 7, a paper conveying unit 21 and a fixing unit 24 are equipped. An original image reading unit SC is arranged at the upper portion of the main body of the image forming apparatus.

The image forming unit 10Y for forming a yellow colored image has a drum-shaped photoreceptor 1Y as a primary image carrier, and a charging unit 2Y, exposing unit 3Y, developing unit 4Y, a primary transferring roller 5Y as a primary transferring unit and a cleaning unit 6Y which are arranged around the photoreceptor 1Y. The image forming unit 10M for forming a magenta colored image has a drum-shaped photoreceptor 1M, and a charging unit 2M, exposing unit 3M, developing unit 4M, a primary transferring roller 5M as a primary transferring unit and a cleaning unit 6M. The image forming unit 10C for forming a cyan colored image has a drum-shaped photoreceptor 1C, and a charging unit 2C, exposing unit 3C, developing unit 4C, a primary transferring roller 5C as a primary transferring unit and a cleaning unit 6C. The image forming unit 10Bk for forming a black colored image has a drum-shaped photoreceptor 1Bk, and a charging unit 2Bk, exposing unit 3Bk, developing unit 4Bk, a primary transferring roller 5Bk as a primary transferring unit and a cleaning unit 6Bk.

The four image forming units 10Y, 10M, 10C and 10Bk are composed of rotating charge unit 2Y, 2M, 2C and 2BK, image exposing unit 3Y, 3M, 23C and 3BK, rotating developing unit 4Y, 4M, 4C and 4BK, and cleaning unit 5Y, 5M, 5C and 58K, each cleaning the photoreceptor drums 1Y, 1M, 1C and 1BK, around the photoreceptor drums 1Y, 1M, 1C and 1BK.

The image forming units 10Y, 10M, 10C and 10Bk are similar except that the color of toner image formed on the photoreceptors 1Y, 1M, 1C and 1BK are different, and therefore, the description is detailed representatively taking the image forming unit 10Y.

The image forming units 10Y is composed of charging unit 2Y, exposing unit 3Y, developing unit 4Y and cleaning unit 5Y arranged around a photoreceptor drum 1Y, to form yellow toner image on the photoreceptor drum 1Y. At least the photoreceptor drum 1Y, charging unit 2Y, developing unit 4Y and cleaning unit 5Y are provided integrally among the image forming unit 10Y in one of the embodiment of this invention.

The charging unit 2Y gives uniform potential to the photoreceptor drum 1Y, and a corona discharge type charger 2Y is provided for the photoreceptor drum 1Y.

The image exposure unit 3Y exposes light according to yellow image signal to the photoreceptor 1Y, on which uniform potential has been given by charger 2Y, so as to form a latent image corresponding to the yellow image. Examples of the exposure unit include one composed of LED array emission elements and image forming elements such as SELFOC lens, arranged around the axis of the photoreceptor, and a laser optical system.

The present electrophotographic image forming apparatus is constituted in such a manner that components such as the photoreceptor, development unit, cleaning unit the like are integrated as a cartridge, and this unit may be detachable from the main frame. Further, the process cartridge may be formed as a single detachable unit in such a manner that at least one of a charging unit, an image exposure unit, a development unit, a transfer or separation unit, and a cleaning unit is integrated with a photoreceptor, and it may be arranged to be detachable employing an guiding means such as a rail in the apparatus main frame.

The endless belt-shaped intermediate transferring unit 7 has a semiconductive endless belt-shaped transferring member 70 as a secondary image carrier which is wound on plural rollers and circulatably held.

Color images formed in the image forming units 10Y, 10M, 10C and 10Bk, respectively, are successively transferred onto the circulating endless belt-shaped intermediate transferring member 70 by the primary transferring rollers 5Y, 5M, 5C and 5Bk as the primary transferring unit, thus a color image is synthesized. Paper P as a recording material (a support carrying the finally fixed image such as a plain paper sheet and a transparent sheet) stocked in a paper supplying cassette 20 is supplied by a paper supplying unit 21, and conveyed to a secondary transferring roller 5A as a secondary transferring means through intermediate conveying rollers 22A, 22B, 22C and 22D and a register roller 23. Then the color image is collectively transferred by the secondary transferring onto the paper P. The color image transferred on the paper P is fixed by the fixing unit 24 and conveyed by an output roller 25 to be stood on an output tray 26.

Besides, the toner remained on the endless belt intermediate transferring member 70 is removed by the cleaning unit 6A after the color image is transferred to the paper P by the secondary transferring roller 5A and the paper P is separated by curvature from the intermediate transferring belt.

In the course of the image formation process, the primary transferring roller 5Bk is constantly pressed to the photoreceptor 1Bk. The other primary transferring rollers 5Y, 5M and 5C are each contacted by pressing to the corresponding photoreceptors 1Y, 1M and 1C, respectively, only for the period of image formation.

The secondary transferring roller 5b is contacted by pressing to the endless belt-shaped intermediate transferring member 70 only for the period of the secondary transferring while passing of the paper P.

A frame 8 can be pulled out from the main body A of the apparatus through supporting rails 82L and 82R.

The frame 8 includes the image forming units 10Y, 10M, 10C and 10Bk, and an intermediate transferring unit 7 comprising the endless belt-shaped intermediate transferring member 70.

The image forming units 10Y, 10M, 10C and 10Bk are serially arranged in the perpendicular direction. In the drawing, the endless belt-shaped intermediate transferring unit 7 is arranged at left side of the photoreceptors 1Y, 1M, 1C and 1Bk. The endless belt-shaped intermediate transferring unit 7 included the circulatable endless belt-shaped intermediate transferring member 70 wound with the rollers 71, 72, 73 and 74, the primary transferring rollers 5Y, 5M, 5C and 5Bk, and the cleaning unit 6b.

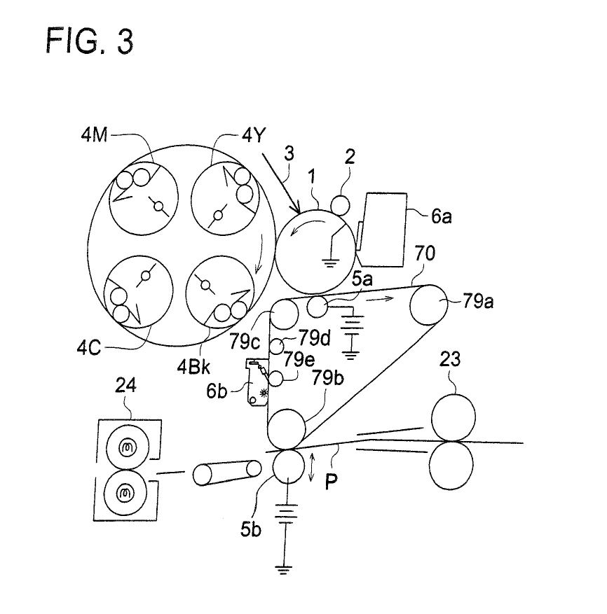

FIG. 3 shows a cross section of a color image forming apparatus employing an organic photoreceptor according to this invention (a copy machine or a laser beam printer having at least an organic photoreceptor and around thereof a charging unit, an exposing unit, a plurality of developing unit, a cleaning unit and an intermediate transferring member). An elastic material having an intermediate electric resistance is used for the intermediate transferring member 70.

The symbol 1 indicates a rotation drum type photoreceptor repeatedly usable as the image forming member, which is anticlockwise rotated at a designated circumference rate.

In the course of the rotation, the photoreceptor 1 is uniformly charged at a designated polarity and electrical potential by a charging unit 2 and then imagewise exposed by scanning by a laser beam modulated by time serial electric digital signals of image information by a imagewise light exposing unit 3, so that an electrostatic latent image corresponding to a yellow (Y) color component of an objective color image is formed.

After that, the electrostatic latent image is developed by a yellow color developing unit 4Y employing a yellow toner as a first color. On this occasion, actions of second through fourth developing unit (a magenta color developing unit, cyan color developing unit and black color developing unit) 4M, 4C and 4Bk are turned off and these developing unit do not affect to the photoreceptor 1 so that the yellow toner image as the first color is not influenced by the second through fourth developing units.

The intermediate transfer member 70 is suspended by rollers 79a, 79b, 79c, 79d and 79e and driven so as to be clockwise rotated in a circumference rate the same as that of the photoreceptor 1.

The first color of the yellow color image carried on the photoreceptor 1 is successively transferred (primary transfer) onto the outer surface of the intermediate transfer member 70 by primary transfer bias applied to the intermediate transfer member 70 from the primary transferring roller 5a.

After the transfer of the yellow color toner image as the first color, the surface of the photoreceptor 1 was cleaned by a cleaning unit 6a.

In the similar manner, a magenta toner image as the second color, cyan toner image as the third color and black toner image are successively transferred onto the intermediate transfer member 70 in pile to form the piled color toner image corresponding to the objective color image.

A secondary transfer roller 5b is releasably arranged so as to be faced to the lower surface of the intermediate in parallel with a secondary transfer counter roller 79b.

The primary bias for successively transferring the toner images of the first to fourth colors is reversal in the polarity to that of the toner and is applied from a bias power source. The applying voltage of it is, for example, within the range of from +100 V to +2 kV.

In the primary transferring process of the first to third color toner images from the photoreceptor 1 to the intermediate transfer member 70, the secondary transferring roller 5b and the intermediate transfer member cleaning unit 6b can be released from the intermediate transferring member 70.

In the course of the transfer of the piled color toner image transferred onto the belt-shaped intermediate transfer member 70 to the image receiving material P as a secondary image carrier, the secondary transferring roller 5b is contacted to the belt of the intermediate transfer member 70, at the same time the image receiving material P is supplied on designated timing by a pare of paper supplying resist rollers 23 through an image receiving paper guide to the contacting nip of the intermediate transfer member 70 with the secondary transfer roller 5b. The secondary bias is applied from a bias power source to the secondary transfer roller 5b. The piled color toner image is transferred to the intermediate transfer member 70 to the image receiving material P as the second image carrier (secondary transfer) by the secondary transferring bias. The image receiving material P, on which the toner image is received, is introduced into a fixing unit 24 and thermally fixed.

The organic photoreceptor of the present invention is applicable to such an electrophotographic apparatus in general as an electrophotographic copying machine, laser printer, LED printer and liquid crystal shutter type printer. Further, it is also applicable over a wide range to a display, recorder, light printer, prepressing machine and facsimile machine that are based on electrophotographic technology.

### EXAMPLES

The invention is illustrated by means Examples. The term “parts” means parts by weight.

### Photoreceptor 1

The photoreceptor 1 was produced as follows.

The cylinder type aluminum base support having machine surface was prepared, which surface has surface roughness Rz of 1.5 μm, having outer diameter of 80 mm and length of 362 mm.

### <Inter Layer>

Coating composition of the inter layer formulated as below was prepared.

| | | |
|---|---|---|
| Polyamide resin X1010, manufactured by | 1 | part |
| Daicel-Degussa Ltd. | | |
| Titanium oxide SMT500SAS, manufactured by | 1.1 | parts |
| TAYCA CORPORATION | | |
| Ethanol | 20 | parts |

The composition was dispersed in batch process for ten hours employing a sand mill dispersion apparatus.

The coating composition was applied on to the support by dipping and thereafter drying at 110° C. for 20 minutes so as to obtain an interlayer having dry thickness of 2 μm.

### <Charge Generation Layer>

The following components were mixed and dispersed by a sand mill for ten hours to prepare a coating composition for charge generation layer.

| | |
|---|---|
| Charge generation material, Titanyl phthalocyanine | 20 part |
| pigment, having a maximum peak at 27.3° based on a | |
| Cu-Kα characteristic X-ray diffraction spectrum | |
| measurement | |
| Polyvinylbutyral resin (#6000-C, manufactured by | 10 parts |
| Denkikagaku Kogyo Kabushiki Kaisha) | |
| t-Butyl acetate | 700 parts |
| 4-Methoxy-4-methyl-2-pentanone | 300 parts |

The coating composition was coated on the interlayer by dipping method to form a charge generation layer having dry thickness of 0.3 μm.

### <Charge Transporting Layer>

| | | |
|---|---|---|
| Charge transporting material (shown below) | 150 | parts |
| Binder, Polycarbonate (Z300: manufactured by | 300 | parts |
| Mitsubishi Gas Chemical Company, Inc.) | | |
| Anti-oxidant (Irganox1010, manufactured by Ninon Ciba | 6 | parts |
| Geigy K.K.) | | |
| Toluene/tetrahydrofuran: 1/9 vol % | 2,000 | parts |
| Silicone oil (KF-54: manufactured by Shin-Etsu Chemical | 1 | part |
| Co., Ltd.) | | |

The above listed compositions were mixed and dissolved to prepare a coating composition for charge transport layer, that was coated on the charge generation layer by dip coat method and dried for 60 minutes at 110° C. to form a charge transport layer having dry thickness of 20 μm.

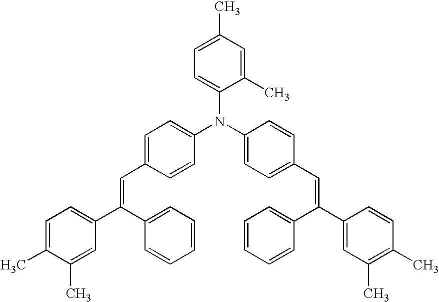

### <Protective Layer>

| | |
|---|---|
| Titanium oxide particles having a reactive organic | 100 parts |
| group (Titanium oxide particles having a number | |
| average primary particle diameter of 6 nm, having | |
| been subjected to surface treatment with the same | |
| amount of methacryloxypropyltrimethoxysilane) | |
| Hardenable Compound (Exemplified compound No. 31) | 100 parts |
| Anti-oxidant (Exemplified compound No. 1-1) | 10 parts |
| Isopropyl alcohol | 500 parts |

The above listed compounds were dispersed for ten hours employing sand mill, then

| | |
|---|---|
| Polymerization initiator 1-6 | 30 parts |

was added and mixed under light shielded condition to prepare a coating composition for the protective layer. It was stored under light shielded condition. The coating composition was coated on the charge transport layer employing circular shape slide hopper to form the protective layer. It was dried for 20 minutes at room temperature to remove solvent, then UV ray was exposed by employing metal halide lamp of 500 W with distance of 100 mm for 1 minute during the photoreceptor is rotating to harden the layer. A protective layer having thickness of 3 μm was formed.

### Preparation of Photoreceptors 2-27

Photoreceptors 2-27 were prepared in the same manner as the photoreceptor 1 except that the materials used for the protective layer and hardening condition of the protective layer were modified shown in Table 1.

Hardening condition by light: Exposing the photoreceptor to UV ray by employing metal halide lamp of 500 W with distance of 100 mm for 1 minute during the photoreceptor is rotating, to form protective layer having thickness of 3 mm.

Hardening condition by heat: Heating for 30 minutes at 140° C. to form protective layer having thickness of 3 mm.

### Preparation of Photoreceptors for Comparison

Photoreceptor 28 (Containing No Anti-Oxidant in Protective layer)

Photoreceptor 28 was prepared in the same manner as the Photoreceptor 1, except that the anti-oxidant was removed from the protective layer.

Photoreceptor 29 (Metal Oxide Particles Surface Treated with a Compound Having No Reactive Organic Group)

Photoreceptor 29 was prepared in the same manner as the Photoreceptor 1, to form an interlayer, a charge generation layer and a charge transport layer.

The protective layer was formed in the same manner as Photoreceptor 1, except that titanium metal oxide particles having a number average primary particle diameter of 6 nm, having been subjected to surface treatment with the same amount of iso-butyltrimethoxysilane was employed.

Photoreceptor 30 (Containing a Hardenable Compound but without Metal Oxide Particles)

Photoreceptor having an interlayer, a charge generation layer and a charge transport layer was prepared in the same way as Photoreceptor 1.

A protective layer was provided thereon in the same way as Photoreceptor 1 except that titanium oxide having organic reactive group was not used.

### Evaluation of the Photoreceptors

### Scratches on the Surface

The photoreceptors were tested in the following ways.

The photoreceptor was mounted on image forming apparatus “bizhub PRO C6500” (produced by Konica Minolta Business Technologies Inc., Tandem type color multifunction apparatus with laser exposure, reversal developing and intermediate transfer) modified so as to conduct evaluation and optimize exposing amount. The test photoreceptor was amounted at cyan image forming unit. Scratches on the surface of the test photoreceptor was observed after printing on neutral paper of 1,000,000 sheets of A4 image having each of yellow, magenta cyan and black of a pixel ratio of 2.5% was successively carried out at 20° C., 50% RH.
A: No scratch was observed after 1,000,000 sheets printing. (Good)
B: One to ten scratches were observed after 1,000,000 sheets printing. (Practically acceptable)
C: Eleven or more scratches were observed after 1,000,000 sheets printing. (Practically not acceptable)

### Abrasion

Abrasion was evaluated by reduction of layer thickness after 1,000,000 sheets as described above. Thickness of the photoreceptor at 10 points at uniform thickness portion were randomly measured (excluding 3 cm end portion, where thickness may not be uniform), and the average of them was referred to the thickness of the photoreceptor. Thickness was measured by an eddy current type instrument EDDY650C manufactured by Helmut Fischer GMBTE CO. Difference of the thickness before and after printing was recorded.
A: Wastage thickness is not more than 1 μm. (Good)
B: Wastage thickness is not more than 1 μm to not more than 3 μm. (Practically acceptable)
C: Wastage thickness is more than 3 μm. (Practically not acceptable)

### Image Blur

Printing test was conducted in the same way as the test of scratches on the surface except that the printing environment was changed at 30° C. and 80 RH, and prints was made on 25,000 sheets of neutral A4 paper, and main power supply was turned off 60 seconds after printing. The power supply was turn on 12 hours thereafter, and an image having half tone image having relative density 0.4 measured by Macbeth reflective densitometer on whole area of A3 paper and an image having 6 dot grid image on whole area of A3 paper were printed out on neutral A3 paper just after the printing became available. Printed image were observed and evaluated as described below.
A: No blur was observed both in half tone image or grid image. (Good)
B: Light web like density depression along with long axis of the photoreceptor only in half tone image. (Practically acceptable)
C: Defects or line depression in grid image due to image blur was observed. (Practically not acceptable)
   The result is summarized in the Tables.

TABLE 1

| | Metal oxide particles | | | | | | |
|---|---|---|---|---|---|---|---|
| Photo- | | | Surface | Treating | Hardenable | | |
| receptor | | Primary | treating | agent/Metal oxide | compound | | |
| No. | Species | Diameter* | agent | particles | No. | Parts | Ac/M |
| 1 | Titanium | 6 | S-15 | 100/100 | 31 | 100 | 0.011 |
| | oxide | | | | | | |
| 2 | Alumina | 6 | S-15 | 100/100 | 7 | 100 | 0.01 |
| 3 | Zinc oxide | 6 | S-15 | 100/100 | 9 | 100 | 0.0067 |
| 4 | Tin oxide | 6 | S-15 | 100/100 | 42 | 100 | 0.0089 |
| 5 | Titanium | 10 | S-15 | 100/100 | 43 | 100 | 0.0091 |
| | oxide | | | | | | |
| 6 | Alumina | 10 | S-30 | 100/100 | 31 | 100 | 0.011 |
| 7 | Zinc oxide | 10 | S-15 | 100/100 | 31 | 100 | 0.011 |
| 8 | Tin oxide | 10 | S-15 | 100/100 | 43 | 100 | 0.0091 |
| 9 | Titanium | 30 | S-15 | 30/100 | 42 | 100 | 0.0089 |
| | oxide | | | | | | |
| 10 | Alumina | 30 | S-15 | 10/100 | 42 | 100 | 0.0089 |
| 11 | Zinc oxide | 30 | S-15 | 100/100 | — | 0 | |
| 12 | Tin oxide | 30 | S-15 | 100/100 | 31 | 100 | 0.011 |
| 13 | Titanium | 20 | S-15 | 100/100 | 7 | 100 | 0.0078 |
| | oxide | | | | | | |
| 14 | Titanium | 50 | S-15 | 100/100 | 9 | 100 | 0.0067 |
| | oxide | | | | | | |
| 15 | Titanium | 70 | S-15 | 100/100 | 42 | 100 | 0.0089 |
| | oxide | | | | | | |
| 16 | Titanium | 6 | S-15 | 10/100 | 42 | 100 | 0.0089 |
| | oxide | | | | | | |
| 17 | Titanium | 6 | S-7 | 100/100 | 42 | 100 | 0.0089 |
| | oxide | | | | | | |
| 18 | Titanium | 6 | S-8 | 100/100 | 42 | 100 | 0.0089 |
| | oxide | | | | | | |
| 19 | Titanium | 6 | S-14 | 100/100 | 42 | 100 | 0.0089 |
| | oxide | | | | | | |
| 20 | Titanium | 6 | S-16 | 100/100 | 42 | 100 | 0.0089 |
| | oxide | | | | | | |
| 21 | Titanium | 6 | S-21 | 100/100 | 42 | 100 | 0.0089 |
| | oxide | | | | | | |
| 22 | Alumina | 10 | S-22 | 100/100 | 42 | 100 | 0.0089 |
| 23 | Alumina | 10 | S-23 | 100/100 | 42 | 100 | 0.0089 |
| 24 | Alumina | 10 | S-26 | 100/100 | 42 | 100 | 0.0089 |
| 25 | Alumina | 10 | S-37 | 100/100 | 42 | 100 | 0.0089 |
| 26 | Alumina | 10 | S-41 | 100/100 | 57 | 100 | — |
| 27 | Alumina | 10 | S-43 | 100/100 | 47 | 100 | — |
| 28 | Titanium | 6 | S-15 | 100/100 | 31 | 100 | 0.011 |
| | oxide | | | | | | |
| 29 | Titanium | 6 | iBTSi** | 100/100 | 31 | 100 | 0.011 |
| | oxide | | | | | | |
| 30 | None | — | None | | 31 | 100 | 0.011 |

| | Polymerization | | | | | | | |
|---|---|---|---|---|---|---|---|---|
| Photo- | initiator | | Anti-oxidant | | | Evaluation Rank | | |
| receptor | Compound | | | Amount | Hardening | Surface | | Image |
| No. | No. | Parts | Spices | (Parts) | condition | scratch | Abrasion | blur |
| 1 | 1-6 | 30 | 1-1 | 10 | Light | A | A | B |
| 2 | 1-6 | 30 | 1-5 | 5 | Light | A | A | B |
| 3 | 1-6 | 30 | 1-6 | 10 | Light | B | A | B |
| 4 | 1-6 | 30 | 1-8 | 5 | Light | A | A | A |
| 5 | 1-6 | 30 | 2-7 | 15 | Light | A | A | A |
| 6 | 1-6 | 30 | 2-1 | 20 | Light | A | A | B |
| 7 | 5-1 | 30 | 1-1 | 10 | Heat | B | B | A |
| 8 | 5-1 | 30 | 1-6 | 30 | Heat | B | B | A |
| 9 | 1-6 | 30 | 1-9 | 10 | Light | A | A | A |
| 10 | 1-6 | 30 | 1-8 | 5 | Light | A | A | A |
| 11 | 1-6 | 15 | 1-6 | 30 | Light | B | B | B |
| 12 | 1-6 | 30 | 1-1 | 10 | Light | A | A | B |
| 13 | 1-6 | 30 | 1-1 | 10 | Light | A | A | B |
| 14 | 1-6 | 30 | 1-1 | 10 | Light | B | A | B |
| 15 | 1-6 | 30 | 2-7 | 15 | Light | A | A | A |
| 16 | 1-6 | 30 | 1-1 | 20 | Light | B | A | B |
| 17 | 1-6 | 30 | 1-2 | 15 | Light | A | A | B |
| 18 | 1-6 | 30 | 1-5 | 15 | Light | B | A | B |
| 19 | 1-6 | 30 | 2-1 | 15 | Light | B | A | A |
| 20 | 1-6 | 30 | 1-9 | 15 | Light | B | A | B |
| 21 | 1-6 | 30 | 1-1 | 5 | Light | B | A | B |
| 22 | 1-6 | 30 | 1-2 | 10 | Light | B | A | B |
| 23 | 1-6 | 30 | 1-6 | 15 | Light | B | A | B |
| 24 | 1-6 | 30 | 1-8 | 20 | Light | A | A | B |
| 25 | 1-6 | 30 | 2-1 | 10 | Light | B | A | B |
| 26 | 6-5 | 30 | 1-9 | 15 | Heat | B | B | B |
| 27 | 6-6 | 30 | 1-1 | 10 | Light | B | B | B |
| 28 | 1-6 | 30 | | | Light | B | B | C |
| 29 | 1-6 | 30 | 1-1 | 10 | Light | C | C | B |
| 30 | 1-6 | 30 | 1-1 | 10 | Light | C | C | B |

*Number average primary diameter
**iso-Butyltrimethoxysilane

The photoreceptors 1-27 according to this invention are evaluated as good or practically acceptable in each evaluation item. Comparative photoreceptors 28-32 are evaluated as practically not acceptable in at least one item.

What is claimed is:

1. An organic photoreceptor comprising a photosensitive layer, provided on an electric conductive support, and a protective layer,
wherein the protective layer comprises,
a composition produced by reacting metal oxide particles having a reactive organic group and,
an anti-oxidant.

2. The organic photoreceptor of claim 1, wherein the metal oxide particles having a reactive organic group is produced by reacting metal oxide particles with a silane compound having a silyl group and carbon-carbon double bond group.

3. The organic photoreceptor of claim 2, wherein the silane compound having a silyl group and carbon-carbon double bond group is represented by the Formula (1), 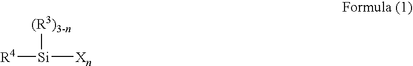
wherein R³ is an alkyl having carbon atoms of from 1 to 10 or an aralkyl having carbon atoms of from 6 to 10, R⁴ is an organic group having polymerizable double bond, X is a halogen atom, an alkoxy, acyloxy, aminooxy or phenoxy group, n is an integer of from 1 to 3.

4. The organic photoreceptor of claim 3, wherein R³ is a hydrogen atom, a methyl or ethyl group.

5. The organic photoreceptor of claim 3, wherein R⁴ is CH₂═CH—, CH₂═CHCOO—, CH₂═CHCOO(CH₂)₂—, CH₂═CHCOO(CH₂)₃—, CH₂═C(CH₃)COO—, CH₂═C(CH₃)COO(CH₂)₂— or CH₂═C(CH₃)COO(CH₂)₃—.

6. The organic photoreceptor of claim 3, wherein X is a halogen atom or an alkoxy group.

7. The organic photoreceptor of claim 1, wherein the reactive organic group is an acryloyl or methacryloyl group.

8. The organic photoreceptor of claim 1, wherein the protective layer is formed by reacting the reactive organic group of the metal oxide particles having a reactive organic group with each other.

9. The organic photoreceptor of claim 1, wherein the protective layer is formed by reacting the reactive organic group of the metal oxide particles having a reactive organic group with a hardenable compound.

10. The organic photoreceptor of claim 9, wherein the hardenable compound is a compound having carbon-carbon double bond.

11. The organic photoreceptor of claim 10, wherein the hardenable compound contains an acryloyl or methacryloyl group.

12. The organic photoreceptor of claim 1, wherein the anti-oxidant is a compound having a hindered phenol group.

13. The organic photoreceptor of claim 1, wherein the anti-oxidant is a compound having a hindered amine group.

14. A manufacturing method of an organic photoreceptor comprising a photosensitive layer, provided on an electric conductive support, and a protective layer, the method comprises steps of;
forming the photosensitive layer on the support, and
forming the protective layer thereon, which comprises steps of;
mixing metal oxide particles with a silane compound having a silyl group and carbon-carbon double bond group to obtain a metal oxide particles having a reactive organic group to obtain metal oxide particles having a reactive organic group,
adding an anti-oxidant metal oxide to the particles having a reactive organic group to obtain a coating composition of the protective layer,
coating the coating composition of the protective layer on the photosensitive layer, and
hardening the coated composition of the protective layer via polymerization reaction.

15. A manufacturing method of claim 14, wherein a hardenable compound having carbon-carbon double bond is further added in the adding step.

16. A manufacturing method of claim 14, wherein the metal oxide particles are titanium oxide, alumina zinc oxide and tin oxide particles.

17. A manufacturing method of claim 14, wherein a number average particle diameter of the metal oxide particles is 1-300 nm.

18. A manufacturing method of an organic photoreceptor comprising a photosensitive layer, provided on an electric conductive support, and a protective layer, the method comprises steps of forming the photosensitive layer on the support, and forming the protective layer thereon, wherein the protective layer is formed by steps of;
applying a protective layer coating composition comprising a metal oxide particles having a reactive organic group and anti-oxidant, and
exposing actinic ray to or heating the coated composition to react the metal oxide particles having a reactive organic group.

19. A manufacturing method of claim 14, wherein the hardening is conducted by photopolymerization or thermal polymerization.

20. An image forming apparatus comprising a charging unit, an imagewise exposing unit and a developing unit arranged around the organic photoreceptor of claim 1.

21. A process cartridge used for the image forming apparatus of claim 19 comprising the organic photoreceptor of claim 1 and at least one of a charging unit, exposing unit and a developing unit integrally, wherein the process cartridge is detachable from main frame of the image forming apparatus.
